(19) United States
(12) Patent Application Publication
(10) Pub. No.: US 2015/0030232 A1
(43) Pub. Date: Jan. 29, 2015

(54) IMAGE PROCESSOR CONFIGURED FOR EFFICIENT ESTIMATION AND ELIMINATION OF BACKGROUND INFORMATION IN IMAGES

(71) Applicant: LSI Corporation, San Jose, CA (US)

(72) Inventors: Denis V. Parkhomenko, Moscow (RU); Ivan L. Mazurenko, Moscow (RU); Denis V. Parfenov, Moscow (RU); Pavel A. Aliseychik, Moscow (RU); Denis V. Zaytsev, Moscow (RU)

(73) Assignee: LSI Corporation, San Jose, CA (US)

(21) Appl. No.: 14/170,041

(22) Filed: Jan. 31, 2014

(30) Foreign Application Priority Data
Jul. 29, 2013 (RU) 2013135506

(51) Int. Cl. G06T 5/00

(52) U.S. Cl. CPC G06T 5/002
USPC 382/154

(57) ABSTRACT

An image processing system comprises an image processor implemented using at least one processing device and adapted for coupling to an image source, such as a depth imager. The image processor is configured to compute a convergence matrix and a noise threshold matrix, to estimate background information of an image utilizing the convergence matrix, and to eliminate at least a portion of the background information from the image utilizing the noise threshold matrix. The background estimation and elimination may involve the generation of static and dynamic background masks that include elements indicating which pixels of the image are part of respective static and dynamic background information. The computing, estimating and eliminating operations may be performed over a sequence of depth images, such as frames of a 3D video signal, with the convergence and noise threshold matrices being recomputed for each of at least a subset of the depth images.

### CROSS-REFERENCE TO RELATED APPLICATION

This application claims foreign priority to Russia Patent Application No. 2013135506, filed on Jul. 29, 2013, the disclosure of which is incorporated herein by reference.

### FIELD

The field relates generally to image processing, and more particularly to processing of background information in depth images and other types of images.

### BACKGROUND

A wide variety of different techniques are known for processing background information in images. Typically, background information is processed over a sequence of images, such as successive frames of a video signal. For example, various techniques are known for eliminating background information in a sequence of images. Such techniques can produce acceptable results when applied to two-dimensional (2D) images. However, many important machine vision applications utilize depth maps or other types of three-dimensional (3D) images generated by depth imagers such as structured light (SL) cameras or time of flight (ToF) cameras. Such images are more generally referred to herein as depth images, and may include low-resolution images having highly noisy and blurred edges.

Conventional background processing techniques generally do not perform well when applied to depth images. For example, these conventional techniques often fail to differentiate with sufficient accuracy between background information and one or more objects of interest within a given depth image. This can unduly complicate subsequent image processing operations such as feature extraction, gesture recognition, automatic tracking of objects of interest, and many others.

### SUMMARY

In one embodiment, an image processing system comprises an image processor implemented using at least one processing device and adapted for coupling to an image source, such as a depth imager. The image processor is configured to compute a convergence matrix and a noise threshold matrix, to estimate background information of an image utilizing the convergence matrix, and to eliminate at least a portion of the background information from the image utilizing the noise threshold matrix.

By way of example only, eliminating at least a portion of the background information from the image may comprise generating a static background mask in which elements corresponding to respective pixels of the image that are part of static background information each take on a particular designated value. It is also possible to generate a dynamic background mask in which elements corresponding to respective pixels of the image that are part of dynamic background information each take on a particular designated value. Such masks may be used to control which pixels of the image are subject to further processing operations in the image processor.

The computing, estimating and eliminating operations mentioned above may be performed over a sequence of depth images, such as frames of a 3D video signal, with the convergence matrix and the noise threshold matrix being recomputed for each of at least a designated subset of the depth images of the sequence.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor with background estimation and elimination functionality in one embodiment.

FIG. 2 shows a more detailed view of a portion of the image processor of FIG. 1 illustrating the operation of its background estimation and elimination functionality.

### DETAILED DESCRIPTION

Embodiments of the invention will be illustrated herein in conjunction with exemplary image processing systems that include image processors or other types of processing devices and implement techniques for estimating and eliminating background information in images. It should be understood, however, that embodiments of the invention are more generally applicable to any image processing system or associated device or technique that involves processing of background information in one or more images.

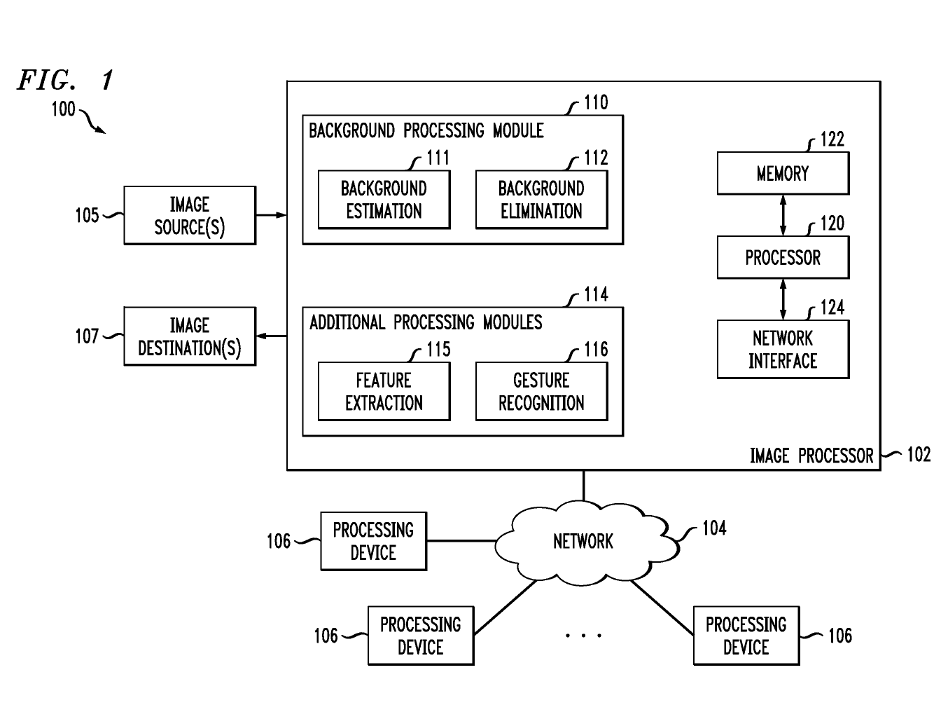

FIG. 1 shows an image processing system 100 in an embodiment of the invention. The image processing system 100 comprises an image processor 102 that receives images from one or more image sources 105 and provides processed images to one or more image destinations 107. The image processor 102 also communicates over a network 104 with a plurality of processing devices 106.

Although the image source(s) 105 and image destination(s) 107 are shown as being separate from the processing devices 106 in FIG. 1, at least a subset of such sources and destinations may be implemented as least in part utilizing one or more of the processing devices 106. Accordingly, images may be provided to the image processor 102 over network 104 for processing from one or more of the processing devices 106. Similarly, processed images may be delivered by the image processor 102 over network 104 to one or more of the processing devices 106. Such processing devices may therefore be viewed as examples of image sources or image destinations.

A given image source may comprise, for example, a 3D imager such as an SL camera or a ToF camera configured to generate depth images, or a 2D imager configured to generate grayscale images, color images, infrared images or other types of 2D images. Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

Also, although the image source(s) 105 and image destination(s) 107 are shown as being separate from the image processor 102 in FIG. 1, the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to perform background estimation and elimination operations on one or more images from a given image source. The resulting image is then subject to additional processing operations such as processing operations associated with feature extraction, gesture recognition, object tracking or other functionality implemented in the image processor 102.

The images processed in the image processor 102 are assumed to comprise depth images generated by a depth imager such as an SL camera or a ToF camera. In some embodiments, the image processor 102 may be at least partially integrated with such a depth imager on a common processing device. Other types and arrangements of images may be received and processed in other embodiments.

The image processor 102 as illustrated in FIG. 1 includes a background processing module 110 having background estimation and background elimination modules 111 and 112. The image processor further comprises additional processing modules 114 such as a feature extraction module 115 and a gesture recognition module 116.

The particular number and arrangement of modules shown in image processor 102 in the FIG. 1 embodiment can be varied in other embodiments. For example, in other embodiments two or more of these modules may be combined into a lesser number of modules. An otherwise conventional image processing integrated circuit or other type of image processing circuitry suitably modified to perform processing operations as disclosed herein may be used to implement at least a portion of one or more of the modules 110, 111, 112, 114, 115 and 116 of image processor 102.

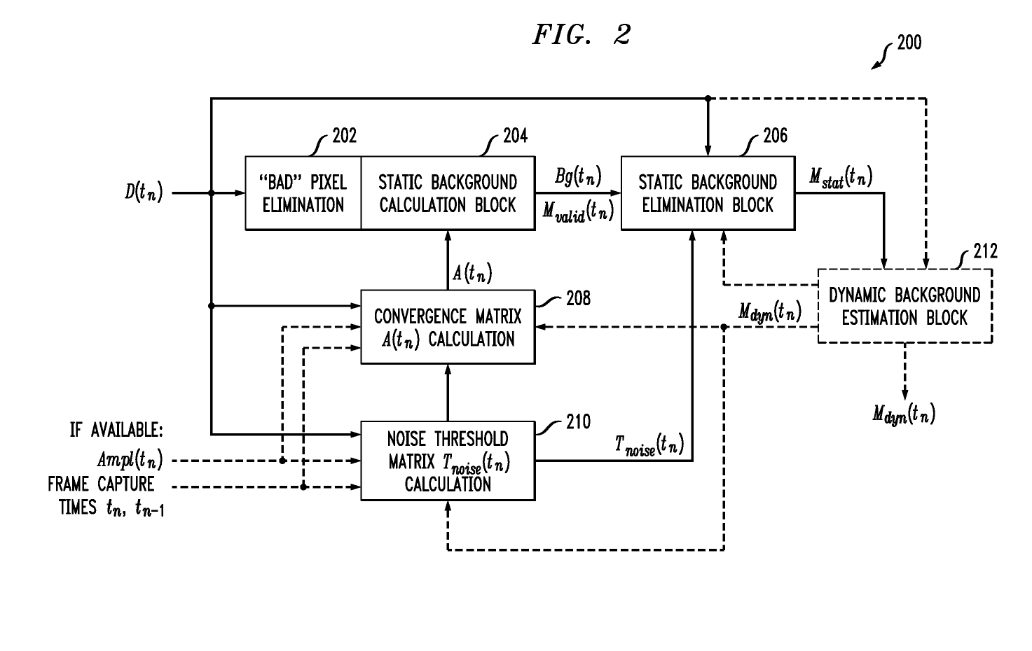

The operation of the background processing module 110 will be described in greater detail below in conjunction with the flow diagram of FIG. 2. This flow diagram illustrates an exemplary process for estimating and eliminating background information in one or more depth images provided by one of the image sources 105.

A modified depth image in which background information has been eliminated in the image processor 102 may be subject to additional processing operations in the image processor 102, such as, for example, feature extraction in module 115, gesture recognition in module 116, or any of a number of additional or alternative types of processing, such as automatic object tracking.

Alternatively, a modified depth image generated by the image processor 102 may be provided to one or more of the processing devices 106 over the network 104. One or more such processing devices may comprise respective image processors configured to perform the above-noted additional processing operations such as feature extraction, gesture recognition and automatic object tracking.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. By way of example, a computer or mobile phone may be configured to incorporate the image processor 102 and possibly a given image source. The image source(s) 105 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as portions of modules 110, 111, 112, 114, 115 and 116. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to applications other than gesture recognition, such as machine vision systems in robotics and other industrial applications.

Referring now to FIG. 2, a portion 200 of an illustrative embodiment of the image processor 102 is shown in more detail. This portion of the image processor is configured for estimating and eliminating background information in depth images in the image processing system 100 of FIG. 1. The portion 200 may be viewed as one possible implementation of the background processing module 110, and includes processing blocks 202 through 212, one or more of which may be implemented at least in part utilizing software executing on image processing hardware of the image processor 102.

It is assumed in this embodiment that an input image received in the image processor 102 from an image source 105 comprises a depth map or other depth image from a depth imager such as an SL camera or a ToF camera. The term “depth image” as used herein is intended to be broadly construed so as to encompass depth maps as well as other types of 3D images that include depth information.

The depth image is further assumed to correspond to one of a sequence of images in a 3D video signal supplied by the depth imager to the image processor, and to comprise a rectangular array of picture elements, also referred to as pixels. Such images in the context of the 3D video signal are also referred to as frames.

Accordingly, in the present embodiment, processing operations associated with estimation and elimination of background information may be performed over a sequence of depth images, such as frames of a 3D video signal.

A given depth image captured at or otherwise associated with a particular frame time tₙ, is denoted in FIG. 2 as input image D(tₙ). For example, D(tₙ) may denote a particular frame of the 3D video signal captured at time tₙ by an image sensor of the depth imager. Many depth imagers use a variable or floating frame rate, in which generally tₙ−tₙ₋₁≢tₙ₋₁−tₙ₋₂, where tᵢ denotes the capture time of the i-th frame. A given pixel with coordinates (i,j) in input image D(tₙ) has a pixel value that is denoted herein as D(tₙ,i,j).

In some embodiments, the input image D(tₙ) is supplied directly to the image processor 102 from a depth imager. However, such an image may be subject to one or more preprocessing operations, in the image processor 102 or elsewhere in the system, before being subject to the processing operations illustrated in FIG. 2.

The input image D(tₙ) is applied to a “bad” pixel elimination block 202 in FIG. 2. This processing block eliminates pixels in the input image that have unexpectedly high or low pixel values due to depth sensing imperfections, and may be configured to operate using estimates of depth variance across pixels. Such pixels usually appear on or near object edges in the case of SL cameras and on pixels far from an object of interest in the case of ToF cameras. Certain types of “bad” pixels such as those associated with light emitters or light reflectors in an imaged field of view can occur for both SL and ToF cameras.

Elimination of “bad” pixels may involve, for example, removing those pixels by replacing them with other predetermined values, such as zero or one values or a designated average pixel value. However, it should be noted that terms such as “eliminate” and “eliminating” as used herein in the context of a given pixel should not be construed as being limited to replacement, modification or other type of removal of that pixel, and are instead intended to be more broadly construed so as to encompass, for example, association of a mask with the image where the mask indicates whether or not particular pixels are to be used in subsequent processing operations.

The depth image with “bad” pixels removed or otherwise eliminated is applied to static background calculation block 204. Other processing blocks in the portion 200 that directly receive the input image D(tₙ) include a static background elimination block 206, a convergence matrix calculation block 208 and a noise threshold matrix calculation block 210. Also shown is a dynamic background estimation block 212, illustrated in dashed outline. This block and its associated signaling, as well as other signaling indicated by dashed lines in FIG. 2, are considered optional in the context of the FIG. 2 embodiment. However, this should not be construed as an indication that other processing blocks or associated signaling are required in the FIG. 2 embodiment or in any other embodiment of the invention.

The convergence matrix A(tₙ) computed in block 208 is used to manage the speed of the static background estimation process in block 204. It will be assumed that the convergence matrix A(tₙ)={α_{i,j}(tₙ)} has the same dimensions or size as the input image D(tₙ). In addition, it is assumed that the size of D(tₙ) is the same as the size of D(tₙ₋₁), and that 0≦α_{i,j}(tₙ)≦1, for positive integers n, i and j. The coefficient matrix A(tₙ)={α_{i,j}(tₙ)} is configured to facilitate generation of a background estimate that closely tracks actual background information, as will be described in greater detail below.

The static background calculation block 204 generates a current background estimate Bg(tₙ) based on exponential averaging of a previous background estimate Bg(tₙ₋₁) generated for the previous frame and the current input image D(tₙ) using the convergence matrix A(tₙ), in accordance with the following equation:

Bg(tₙ)=Bg(tₙ₋₁).*A(tₙ)+(I−A(tₙ)).*D(tₙ),

where .* denotes an element-wise matrix multiplication operator and I denotes the identity matrix.

The background estimate Bg(tₙ) at the output of the static background calculation block 204 is provided as an input to the static background elimination block 206. The output of the static background elimination block 206 is a static background mask Mₛₜₐₜ(tₙ) which is also provided as an input to the dynamic background estimation block 212. This block generates a dynamic background mask M_{dyn}(tₙ) that may also be fed back to processing blocks 206, 208 and 210. The masks Mₛₜₐₜ(tₙ) and M_{dyn}(tₙ) are assumed to be in the form of respective matrices having the same dimensions or size as the input image D(tₙ).

The static background elimination block 206 uses a noise threshold matrix Tₙₒᵢₛₑ(tₙ) calculated in block 210 to generate a modified image in which background information has been eliminated. It is assumed that the noise threshold matrix Tₙₒᵢₛₑ(tₙ)={τ(tₙ,i,j)} has the same dimensions or size as the input image D(tₙ) and the convergence matrix A(tₙ). The noise threshold matrix may vary depending upon the particular type of depth imager that is used to generate the input images but may include, for example, data indicating dependency of noise level on amplitude or depth for each pixel of the image. If no such data is available, it is possible to instead set τ(tₙ,i,j)=1 for positive integers n, i and j.

As illustrated in FIG. 2, the calculation of the convergence matrix A(tₙ) and the noise threshold matrix Tₙₒᵢₛₑ(tₙ) in respective blocks 208 and 210 may utilize amplitude information denoted Ampl(tₙ). Such information may be provided as a separate intensity image from an SL or ToF camera or other type of depth imager. Alternatively, if calibration information is available from a depth imager, that information may be used in place of or in addition to the amplitude information Ampl(tₙ).

Processing blocks 208 and 210 may also receive timing information illustratively shown in FIG. 2 as frame capture times tₙ and tₙ₋₁. Operations such as the computation of the convergence matrix and the noise threshold matrix in the respective processing blocks 208 and 210 may be repeated for each of at least a subset of a plurality of depth images in a sequence of such depth images. For example, such computations may be repeated for each depth image in the sequence. Alternatively, such computations may be repeated only for every other depth image in the sequence, or for each of other designated subsets of the depth images in the sequence.

Other types of information may be provided to one or more of the exemplary processing blocks shown in FIG. 2. For example, feedback information may be provided from one or more higher level processing blocks such as blocks associated with feature extraction module 115, gesture recognition module 116 or other blocks that are part of the additional processing modules 114 in image processor 102.

As a more particular example, such higher level processing blocks may identify one or more objects of interest within the image and provide a corresponding mask to the processing blocks 208 and 210. In the FIG. 2 embodiment, such mask generation associated with an object of interest can additionally or alternatively be provided using the dynamic background estimation block 212 rather than a higher level processing block.

The background estimation process implemented in FIG. 2 can also take into account additional known information about the object of interest in a particular image processing application. For example, in a head tracking application, information regarding approximate head shape is known, so the background estimation process can exclude from consideration all objects that are not similar to the known head shape. Again, in the FIG. 2 embodiment, this may be achieved using the dynamic background estimation block 212, a higher level processing block, or a combination of both.

Each of the processing blocks 202, 204, 206, 208, 210 and 212 of portion 200 of image processor 102 will be described in greater detail below.

The “bad” pixel elimination block is illustratively shown in FIG. 2 as being closely associated with the static background calculation block 204 and in other embodiments these blocks may be combined into a single integrated block.

Detection of “bad” pixels may be based on observations of corresponding random variables characterizing depth values δ(i,j) over time. For example, a “bad” pixel may be indicated by a high standard deviation in such a random variable. As a more particular example, the (i,j)-th pixel may be considered “bad” if and only if:

Bg₂(tₙ,i,j)−Bg(tₙ,i,j)²<λ,

where

Bg₂(tₙ)=Bg₂(tₙ₋₁).*A(tₙ)+(I−A(tₙ)).*D(tₙ)²,

and λ is a predefined depth threshold (e.g., λ=1 meter). Here, it is further assumed that Bg₂(t₀)=Bg₀². The resulting output of the “bad” pixel elimination block may be in the form of a validity matrix:

M_{valid}={μ_{i,j}},

in which μ_{i,j}=0 if the (i,j)-th pixel is “bad” and otherwise μ_{i,j}=1. The validity matrix therefore identifies particular pixels of the input image D(tₙ) that are considered “bad” and can therefore be eliminated from further processing by, for example, replacing those pixels with known fixed values, such as zero depth values. Such elimination may be implemented within “bad” pixel elimination block 202. The corresponding validity matrix is also provided as an output for use in other processing blocks, such as static background elimination block 206. For example, elimination of the “bad” pixels may be performed in conjunction with elimination of static background information in block 206.

As indicated previously, the static background estimation block 204 generates background estimate Bg(tₙ) for input image D(tₙ). The background estimate is assumed to be in the form of a matrix having the same size as D(tₙ). It is computed using exponential averaging based on the coefficients of the convergence matrix A(tₙ)={α_{i,j}(tₙ)}, although other smoothing techniques may be used in other embodiments. More particularly, the background estimate Bg(tₙ) is generated in accordance with the following equation:

Bg(tₙ)=Bg(tₙ₋₁).*A(tₙ)+(I−A(tₙ)).*D(tₙ),

where as noted above .* denotes an element-wise matrix multiplication operator and I denotes the identity matrix. Initialization of Bg(t₀) may be implemented using a matrix Bg₀, which may comprise, for example, a matrix of zero values or other constant values.

The calculation of the convergence matrix A(tₙ) in block 208 will now be described in greater detail. The convergence matrix A(tₙ) includes a separate convergence coefficient α_{i,j}(tₙ), 0≦α_{i,j}(tₙ)≦1, for each pixel of the input image D(tₙ). Each such coefficient may depend not only on the frame index n and the position and value of the corresponding pixel but also on capture time tₙ and optionally on additional external information such as the dynamic background mask M_{dyn}(tₙ) from the dynamic background estimation block 212. Such dependencies can take into account frame capture irregularities as well as the above-noted amplitude information for particular pixels. For example, in some embodiments, the coefficients may be configured such that the greater the depth value of a pixel, the higher the probability that the pixel is part of the background.

As a more particular example, each of the convergence coefficients α_{i,j}(tₙ) of the convergence matrix A(tₙ) may be calculated in accordance with the following equation:

$${α}_{i , j} ( {t}_{n} ) = \{ \begin{matrix}\frac{{s}_{1} ( {t}_{n} , {t}_{n - 1} , Ampl ( {t}_{n} , i , j ) )}{D ( {t}_{n} , i , j )} & if {M}_{dyn} ( {t}_{n} , i , j ) = 0 \\ \frac{{s}_{2} ( {t}_{n} , {t}_{n - 1} , Ampl ( {t}_{n} , i , j ) )}{D ( {t}_{n} , i , j )} & if {M}_{dyn} ( {t}_{n} , i , j ) = 1\end{matrix}$$

where s₁(.) and s₂(.) are convergence speed variables that depend on time and input depth and amplitude values. This particular example assumes availability of the dynamic background estimation block 212 of FIG. 2. However, if the block 212 is not present in a given embodiment, the above equation may be modified such that M_{dyn}(tₙ,i,j)=0 for all i, j and n. Also, if the amplitude information provided by matrix Ampl(tₙ) is not available, the dependency of s₁(.) and s₂(.) on amplitude can be eliminated.

In the above equation for the calculation of the convergence coefficients α_{i,j}(tₙ), the variables s₁(.) and s₂(.) may be determined as follows:

$${s}_{1} ( {t}_{n} , {t}_{n - 1} , Ampl ( {t}_{n} , i , j ) ) = \{ \begin{matrix}{\hat{α}}^{\frac{{t}_{n} - {t}_{n - 1}}{m}} , & if {γ}_{1} < Ampl ( {t}_{n} , i , j ) < {γ}_{2} \\ {\hat{β}}^{\frac{{t}_{n} - {t}_{n - 1}}{m}} , & else\end{matrix} , \\ where 0 < \hat{α} < \hat{β} < 1 , 0 < {γ}_{1} < {γ}_{2} , \\ {s}_{2} ( {t}_{n} , {t}_{n - 1} , Ampl ( {t}_{n} , i , j ) ) = \{ \begin{matrix}{\hat{χ}}^{\frac{{t}_{n} - {t}_{n - 1}}{m}} , & if {γ}_{1} < Ampl ( {t}_{n} , i , j ) < {γ}_{2} \\ {\hat{ψ}}^{\frac{{t}_{n} - {t}_{n - 1}}{m}} , & else\end{matrix} , \\ where 0 < \hat{χ} < \hat{ψ} < 1.$$

The above equations for s₁(.) and s₂(.) provide time-based convergence speed in the convergence coefficients α_{i,j}(tₙ), in that the greater the time difference between frame capture times tₙ and tₙ₋₁, the greater the convergence speeds \hat{α}, \hat{β}, \hat{χ} and \hat{Ψ}. This time-based convergence speed approach significantly reduces the adverse effects of any discontinuities in the incoming image data, while also limiting the computational complexity of the overall background estimation and elimination process. For example, time-based convergence speed in accordance with the above equations makes it possible in some embodiments to execute the convergence matric calculation block 208 only on certain input images, such as on every other image or every third image in a given image sequence, without significant loss of quality. Similarly, blocks such as 202, 204 and 210 need not be performed on every image in a given image sequence.

The convergence matrix A(tₙ) generated in the manner described above is provided by block 208 to the static background elimination calculation block 204. It is utilized in block 204 to compute the background estimate Bg(tₙ) that is provided to the static background elimination block 206.

The static background elimination block 206 utilizes the background estimate Bg(tₙ) and the noise threshold matrix Tₙₒᵢₛₑ(tₙ) from block 210 to separate the input image D(tₙ) into two non-overlapping portions, namely, a background portion and a foreground portion. By way of example, this separation may be performed by generating the static background mask Mₛₜₐₜ(tₙ) on a per-pixel basis in accordance with the following equation:

$${M}_{stat} ( {t}_{n} , i , j ) = \{ \begin{matrix}1 , & if D ( {t}_{n} , i , j ) - Bg ( {t}_{n} , i , j ) > τ ( {t}_{n} , i , j ) \\ 0 , & else\end{matrix} ,$$

where τ(tₙ,i,j) is a particular element of the noise threshold matrix Tₙₒᵢₛₑ(tₙ). The above equation in matrix form may be expressed as:

Mₛₜₐₜ(tₙ)=(D(tₙ)−Bg(tₙ)>Tₙₒᵢₛₑ(tₙ)),

where Mₛₜₐₜ(tₙ) represents the static background of the input image D(tₙ), such that a given static background mask element Mₛₜₐₜ(tₙ,i,j)=1 if and only if the corresponding (i,j)-th pixel of D(tₙ) is part of the static background.

Accordingly, in this embodiment, static background elimination involves comparing the difference between the input image D(tₙ) and the static background estimate Bg(tₙ) with the noise threshold Tₙₒᵢₛₑ(tₙ). Any pixel of the input image D(tₙ) that is more than the noise threshold deeper than the corresponding element of the current background estimate is considered static background and the rest of the input image is considered foreground.

In some embodiments, additional or alternative processing may be performed in the static background elimination block 206. For example, if a given image processing application requires a denoised foreground, the computation of the static background mask Mₛₜₐₜ(tₙ) may utilize the validity matrix M_{valid}(tₙ) as follows:

Mₛₜₐₜ(tₙ)=(D(tₙ)−Bg(tₙ)>Tₙₒᵢₛₑ(tₙ)).*(I−M_{valid}(tₙ)).

In this example, use of the validity matrix ensures that input image pixels D(i,j) with corresponding static background mask values Mₛₜₐₜ(tₙ,i,j)=0 are part of a denoised foreground of the input image.

Other embodiments can modify the static background elimination block 206 to take into account not only the input image D(tₙ), background estimate Bg(tₙ) and noise threshold matrix Tₙₒᵢₛₑ(tₙ), but also the standard deviation of the background estimate, in order to provide improved robustness. For example, block 206 can be modified to calculate a background estimate standard deviation matrix Bg_std(tₙ), and then apply it in the static background elimination process as follows:

Bg_std(tₙ,i,j)=sqrt(Bg₂(tₙ,i,j)−Bg(tₙ,i,j)²),

where matrices Bg₂ and Bg are the same as those previously described in the context of the “bad” pixel elimination block 202. The final decision may be made in accordance with the following equation:

$${M}_{stat} ( {t}_{n} , i , j ) = \{ \begin{matrix}1 , & \begin{matrix}if D ( {t}_{n} , i , j ) < Bg ( {t}_{n} , i , j ) - {N}_{s} \cdot \\ Bg\_std ( {t}_{n} , i , j ) or Bg\_std ( {t}_{n} , i , j ) < τ ( {t}_{n} , i , j )\end{matrix} \\ 0 , & else\end{matrix}$$

This equation in matrix form is as follows:

Mₛₜₐₜ(tₙ)=(D(tₙ)<Bg(tₙ)−Nₛ·Bg_std(tₙ)))or ((Bg_std(tₙ)<Tₙₒᵢₛₑ(tₙ)).

In these equations, the variable Nₛ denotes the number of “sigmas” in the above-described decision rule. A suitable value for Nₛ in the present embodiment is 3, although other values can be used.

The calculation of the noise threshold matrix Tₙₒᵢₛₑ(tₙ) in block 210 will now be described in greater detail. This calculation may vary depending upon the type of depth imager used to generate the input images. For example, different noise models may be associated with SL cameras and ToF cameras.

In the case of an SL camera, where noise level is typically a function of squared range resolution, the noise threshold matrix may be computed as follows:

Tₙₒᵢₛₑ(tₙ,i,j)=θ·D(tₙ,i,j)²,

where θ≢0 is a real-valued constant (e.g., θ=1).

In the case of a ToF camera, where noise level is typically inversely proportional to reflected signal amplitude, the noise threshold matrix may be computed as follows:

$${T}_{noise} ( {t}_{n} , i , j ) = \{ \begin{matrix}\frac{{θ}_{1}}{Ampl ( {t}_{n} , i , j )} , & if Ampl ( {t}_{n} , i , j ) \neq 0 \\ {θ}_{2} , & else\end{matrix} ,$$

where θ₁ and θ₂ are real-valued constants such that θ₁<θ₂. The θ₁ constant should more particularly be selected as linearly proportional to the integration time of the image sensor of the ToF camera, if the value of this parameter is known. For example, in the case of a PMD Nano ToF camera, a suitable value for θ₁ is the integration time divided by ten, and a suitable value for θ₂ is a very large or even infinite value.

The above are just examples of possible noise threshold matrix computations, and other embodiments can use a wide variety of alternative noise thresholds, possibly taking into account known information regarding the noise characteristics of the particular depth imager being utilized.

Also, embodiments that include dynamic background estimation block 212 may base the noise threshold matrix calculation at least in part on the dynamic background mask M_{dyn}(tₙ) provided from block 212 to block 210. This may involve adjusting portions of the noise threshold matrix using information regarding a tracked object of interest. For example, in hand tracking applications, the threshold level can be increased when a tracked hand approaches a designated depth limit of an imaged scene, and decreased when the tracked hand is further from the depth limit.

The operation of the dynamic background estimation block 212 will now be described in greater detail. This block in the present embodiment detects unwanted disturbances in the foreground portion of the image after the static background portion has been determined. Such disturbances may be caused, for example, by movement of objects that are not of any particular interest in the scene, such as objects other than a tracked hand in a hand tracking application. The block 212 may therefore be configured to generate dynamic background mask M_{dyn}(tₙ) using the static background mask Mₛₜₐₜ(tₙ), the input image D(tₙ), and a priori knowledge about foreground dynamics in the particular application.

The output of block 212 is configured such that M_{dyn}(tₙ,i,j)=0 if and only if the (i,j)-th pixel belongs to a tracked object of interest, and M_{dyn}(tₙ,i,j)=1 if and only if the (i,j)-th pixel belongs to the dynamic background. The dynamic background typically refers to the portion of the imaged scene that changes significantly over time but does not include an object of interest, and is distinct from static background which typically refers to the portion of the imaged scene that does not change significantly over time. An object of interest can be any object in an imaged scene that is targeted by an image processing application, such as a tracked object in an object tracking application. The particular configuration of block 212 in a given embodiment may therefore vary depending upon factors such as the type of object being targeted or other application-specific factors.

As one example, the block 212 in a hand tracking application in which the depth imager is installed below the hand with an upward field of view may be more specifically configured in the following manner. The input to the block includes the static background mask Mₛₜₐₜ(tₙ) in which zero-valued elements of the mask denote pixels that are part of the foreground rather than part of the static background. Assume that a tracked hand appears as the closest object to an upper edge of Mₛₜₐₜ(tₙ). In this case, the block 212 may be configured to determine a designated number Q of pixels (e.g., 200 pixels) around a mean depth value of the tracked hand. These Q pixels provide a set of closest pixels Cl(tₙ) that are closest to the tracked hand. The mean depth value may be specified as:

$$mean\_value = \frac{{\sum }_{( i , j ) ∈ Cl ( {t}_{n} )} D ( {t}_{n} , i , j )}{Q} ,$$

and the dynamic background mask M_{dyn}(tₙ) is then determined in accordance with the following equation:

$${M}_{dyn} ( {t}_{n} , i , j ) = \{ \begin{matrix}1 , & \begin{matrix}if \vert D ( {t}_{n} , i , j ) - mean\_value \vert > ρ \\ and {M}_{stat} ( {t}_{n} , i , j ) = 0\end{matrix} \\ 0 , & else\end{matrix} ,$$

where p≧0 denotes a real value. In this example, the block 212 is configured to separate out as dynamic background those pixels that have depth values within a designated range of the mean depth value.

The FIG. 2 processing operations can be pipelined in a straightforward manner. For example, at least a portion of one or more of the processing blocks 202, 204, 206, 208, 210 and 212 can be performed in parallel, thereby reducing the overall latency of the process for a given input image, and facilitating implementation of the described techniques in real-time image processing applications. Also, vector processing in firmware can be used to accelerate at least portions of one or more of the processing blocks.

It is also to be appreciated that the particular processing blocks used in the embodiment of FIG. 2 are exemplary only, and other embodiments can utilize different types and arrangements of image processing operations. For example, the particular techniques used to estimate the static and dynamic background, and the particular techniques used to calculate the convergence matrix and the noise threshold matrix, can be varied in other embodiments. Also, as noted above, one or more processing blocks indicated as being executed serially in the figure can be performed at least in part in parallel with one or more other processing blocks in other embodiments.

Embodiments of the invention provide particularly efficient techniques for estimating and eliminating background information in an image. For example, these techniques can provide significantly better differentiation between background information and one or more objects of interest within depth images from SL or ToF cameras or other types of depth imagers. Accordingly, use of modified depth images having background information estimated and eliminated in the manner described herein can significantly enhance the effectiveness of subsequent image processing operations such as feature extraction, gesture recognition and object tracking.

The techniques in some embodiments can operate directly with raw image data from an image sensor of a depth imager, thereby avoiding the need for denoising or other types of preprocessing operations. Moreover, the techniques exhibit low computational complexity, can be adapted to handle static as well as dynamic backgrounds, and can support many different noise models as well as different types of image sensors having different frame rates including variable or floating frame rates typical of depth imagers.

It should again be emphasized that the embodiments of the invention as described herein are intended to be illustrative only. For example, other embodiments of the invention can be implemented utilizing a wide variety of different types and arrangements of image processing circuitry, modules and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
computing a convergence matrix and a noise threshold matrix;
estimating background information of an image utilizing the convergence matrix; and
eliminating at least a portion of the background information from the image utilizing the noise threshold matrix;
wherein said computing, estimating and eliminating are implemented in at least one processing device comprising a processor coupled to a memory.

2. The method of claim 1 wherein the image comprises a depth image generated by a depth imager.

3. The method of claim 1 further comprising eliminating one or more pixels of the image having designated characteristics prior to estimating the background information of the image.

4. The method of claim 1 wherein estimating background information of the image utilizing the convergence matrix comprises generating a current background estimate Bg(tₙ) for a current image D(tₙ) based on a previous background estimate Bg(tₙ₋₁) generated for a previous image D(tₙ₋₁) in accordance with the following equation:
Bg(tₙ)=Bg(tₙ₋₁).*A(tₙ)+(I−A(tₙ)).*D(tₙ),
where .* denotes an element-wise matrix multiplication operator, A(tₙ) denotes the convergence matrix, and I denotes an identity matrix.

5. The method of claim 1 wherein estimating background information of the image utilizing the convergence matrix comprises estimating static background information of the image utilizing the convergence matrix, and wherein eliminating at least a portion of the background information from the image utilizing the noise threshold matrix comprises eliminating at least a portion of the static background information from the image utilizing the noise threshold matrix.

6. The method of claim 5 wherein eliminating at least a portion of the static background information from the image comprises generating a static background mask in which elements corresponding to respective pixels of the image that are part of the static background information each take on a particular designated value.

7. The method of claim 6 wherein the static background mask comprises elements Mₛₜₐₜ(tₙ,i,j) for respective corresponding (i,j)-th pixels of the image and wherein the elements Mₛₜₐₜ(tₙ,i,j) are computed in accordance with the following equation:
$${M}_{stat} ( {t}_{n} , i , j ) = \{ \begin{matrix}1 , & if D ( {t}_{n} , i , j ) - Bg ( {t}_{n} , i , j ) > τ ( {t}_{n} , i , j ) \\ 0 , & else\end{matrix} ,$$
where D(tₙ,i,j) denotes a particular pixel of the image, Bg(tₙ,i,j) denotes a corresponding element of a static background estimate, and τ(tₙ,i,j) is a corresponding element of the noise threshold matrix.

8. The method of claim 5 further comprising:
estimating dynamic background information of the image; and
eliminating at least a portion of the dynamic background information from the image.

9. The method of claim 8 wherein eliminating at least a portion of the dynamic background information from the image comprises generating a dynamic background mask in which elements corresponding to respective pixels of the image that are part of the dynamic background information each take on a particular designated value.

10. The method of claim 9 wherein the dynamic background mask comprises elements M_{dyn}(tₙ,i,j) for respective corresponding (i,j)-th pixels of the image and wherein M_{dyn}(tₙ,i,j)=0 if the corresponding (i,j)-th pixel of the image belongs to a particular tracked object of interest, and M_{dyn}(tₙ,i,j)=1 if the corresponding (i,j)-th pixel of the image is part of the dynamic background information.

11. The method of claim 9 wherein computing the convergence matrix and the noise threshold matrix further comprises computing at least one of said matrices utilizing the dynamic background mask.

12. The method of claim 1 wherein computing the convergence matrix and the noise threshold matrix further comprises computing at least one of said matrices utilizing amplitude information of said image.

13. The method of claim 1 wherein computing the convergence matrix and the noise threshold matrix further comprises computing at least one of said matrices utilizing capture time information of said image.

14. The method of claim 1 wherein the convergence matrix comprises a plurality of convergence coefficients corresponding to respective pixels of the image and wherein the convergence coefficients are configured to provide a time-based convergence speed that increases with increasing difference between respective capture times of the image and a previous image in a sequence of images.

15. The method of claim 1 wherein said computing, estimating and eliminating are performed over a sequence of depth images and the convergence matrix and the noise threshold matrix are recomputed for each of at least a designated subset of the depth images of the sequence.

16. A computer-readable storage medium having computer program code embodied therein, wherein the computer program code when executed in the processing device causes the processing device to perform the method of claim 1.

17. An apparatus comprising:
at least one processing device comprising a processor coupled to a memory;
wherein said at least one processing device is configured to compute a convergence matrix and a noise threshold matrix, to estimate background information of an image utilizing the convergence matrix, and to eliminate at least a portion of the background information from the image utilizing the noise threshold matrix.

18. The apparatus of claim 17 wherein the processing device comprises an image processor.

19. An integrated circuit comprising the apparatus of claim 17.

20. An image processing system comprising:
an image source providing a sequence of images;
one or more image destinations; and
an image processor coupled between said image source and said one or more image destinations;
wherein the image processor is configured to compute a convergence matrix and a noise threshold matrix, to estimate background information of an image utilizing the convergence matrix, and to eliminate at least a portion of the background information from the image utilizing the noise threshold matrix.

21. The system of claim 20 wherein the image source comprises a depth imager.
